(19) United States
(12) Patent Application Publication
(10) Pub. No.: US 2024/0309517 A1
(43) Pub. Date: Sep. 19, 2024

(54) CARBON DIOXIDE CONVERSION APPARATUS USING A HYDROGEN OXIDATION REACTION AND AN ELECTROCHEMICAL CARBON DIOXIDE CONVERSION METHOD USING THE SAME

(71) Applicant: UIF (University Industry Foundation), Yonsei University, Seoul (KR)

(72) Inventors: Dongil Lee, Gyeonggi-do (KR); Yongsung Jo, Seoul (KR)

(73) Assignee: UIF (University Industry Foundation), Yonsei University, Seoul (KR)

(21) Appl. No.: 18/396,779

(22) Filed: Dec. 27, 2023

(30) Foreign Application Priority Data
Mar. 16, 2023 (KR) 10-2023-0034435
Dec. 26, 2023 (KR) 10-2023-0191053

(51) Int. Cl. C25B 1/23; C25B 9/23; C25B 11/032; C25B 11/081; C25B 11/095

(52) U.S. Cl. CPC C25B 1/23; C25B 9/23; C25B 11/032; C25B 11/081; C25B 11/095

(57) ABSTRACT

The present disclosure relates to a carbon dioxide conversion apparatus for preparing carbon monoxide: including an oxidation electrode; a reduction electrode opposing and spaced apart from the oxidation electrode; and an ion-exchange membrane disposed between the oxidation electrode and the reduction electrode, wherein the oxidation electrode includes a hydrogen oxidation reaction (HOR) catalyst, and the reduction electrode is a gas diffusion electrode including a metal nanocluster catalyst, and an electrochemical carbon dioxide conversion method using the same. According to the present disclosure, the electrical energy required for conversion of carbon dioxide can be decreased significantly and the selectivity for carbon monoxide can be improved.

### CROSS-REFERENCE TO RELATED APPLICATION

This application claims priority to Korean Patent Application Nos. 10-2023-0034435 and 10-2023-0191053 filed on Mar. 16, 2023 and Dec. 26, 2023, respectively, and all the benefits accruing therefrom under 35 U.S.C. § 119, the contents of which in its entirety are herein incorporated by reference.

### BACKGROUND

### 1. Field

The present disclosure relates to a carbon dioxide conversion apparatus using hydrogen oxidation reaction and an electrochemical carbon dioxide conversion method using the same.

### 2. Description of the Related Art

With population growth and industrialization since the Industrial Revolution, the use of fossil fuel has increased, leading to increased greenhouse gas emissions. The increased concentration of greenhouse gases in the atmosphere resulted in the global warming phenomenon in which the average temperature of the Earth rises.

At this juncture, researches are actively underway to capture carbon dioxide, which is the main cause of global warming, and convert it into industrially useful carbon compounds through electrochemical. The carbon dioxide conversion process is a technology that reduces carbon dioxide into useful carbon compounds by applying electrical energy and transporting electrons due to potential difference between electrodes. It is advantageous in that carbon dioxide reduction reaction can be performed even under room temperature and normal pressure conditions, chemicals are not emitted because the electrolyte is recycled and the process is simple.

Electrical energy is necessary to convert the thermodynamically stable carbon dioxide into carbon compounds. Conventionally, in the electrochemical conversion of carbon dioxide, oxygen evolution reaction (OER) mainly occurs as the opposite reaction of carbon dioxide reduction reaction. When carbon dioxide is reduced using oxygen evolution reaction, the theoretical voltage is high as 1.34 V and overpotential is required additionally to overcome the kinetic barrier.

In addition, due to hydrogen evolution reaction (HER) that occurs simultaneously during the carbon dioxide reduction reaction in a similar reduction potential region, selectivity for the carbon dioxide reduction product is decreased. Therefore, the development of a high-performance carbon dioxide conversion apparatus that can improve the selectivity for the carbon dioxide reduction product during the electrochemical conversion of carbon dioxide and an electrochemical carbon dioxide conversion method using the same is necessary.

### SUMMARY

The present disclosure is directed to providing a carbon dioxide conversion apparatus that can remarkably reduce overpotential during electrochemical conversion of carbon dioxide and an electrochemical carbon dioxide conversion method using the same.

A carbon dioxide conversion apparatus for preparing carbon monoxide according to the present disclosure includes: an oxidation electrode; a reduction electrode opposing and spaced apart from the oxidation electrode; and an ion-exchange membrane disposed between the oxidation electrode and the reduction electrode, wherein the oxidation electrode includes a hydrogen oxidation reaction (HOR) catalyst and the reduction electrode is a gas diffusion electrode including a metal nanocluster catalyst.

In the carbon dioxide conversion apparatus according to the present disclosure, the hydrogen oxidation reaction catalyst may include platinum.

In the carbon dioxide conversion apparatus according to the present disclosure, the gas diffusion electrode may include a porous support and a metal nanocluster catalyst fixed in the pores of the porous support.

In the carbon dioxide conversion apparatus according to the present disclosure, the metal nanocluster catalyst may have an average particle diameter of 10 nm or smaller. In the carbon dioxide conversion apparatus according to the present disclosure, the metal nanocluster catalyst may be represented by Chemical Formula 1:

Mₓ(SR)_{y} [Chemical Formula 1]

wherein M is gold or silver, SR is C₁-C₂₀ alkylthiol, C₃-C₂₀ alkenylthiol, C₃-C₂₀ alkynylthiol, C₆-C₂₀ arylthiol, C₃-C₂₀ cycloalkylthiol, C₅-C₂₀ heteroarylthiol, C₃-C₂₀ heterocycloalkylthiol or C₆-C₂₀ aryl C₁-C₂₀ alkylthiol, x is 14, 25, 38 or 144 and y is 18, 24 or 60.

In the carbon dioxide conversion apparatus according to the present disclosure, the metal nanocluster catalyst may be represented by Chemical Formula 2:

AuₓM_{y}(SR)_{z} [Chemical Formula 2]

wherein M is nickel, silver or copper, SR is C₁-C₃₀ alkylthiol, C₆-C₃₀ arylthiol, C₃-C₃₀ cycloalkylthiol, C₅-C₃₀ heteroarylthiol, C₃-C₃₀ heterocycloalkylthiol or C₁-C₃₀ aryl C₁-C₃₀ alkylthiol, x is 2, 4 or 12, y is 2, 3, 4 or 32 and z is 8, 10 or 30.

In the carbon dioxide conversion apparatus according to the present disclosure, the reduction electrode may further include a carbon dioxide inlet and a carbon monoxide outlet on one side, and the oxidation electrode may further include a hydrogen inlet and a water outlet on one side.

In the carbon dioxide conversion apparatus according to the present disclosure, each of the oxidation electrode and the reduction electrode may further include a flow path connecting the inlet and the outlet.

In the carbon dioxide conversion apparatus according to the present disclosure, the oxidation electrode may contact with one side of the ion-exchange membrane.

In the carbon dioxide conversion apparatus according to the present disclosure, the ion-exchange membrane may be an anion-exchange membrane.

The present disclosure provides an electrochemical carbon dioxide conversion method using the carbon dioxide conversion apparatus described above.

The electrochemical carbon dioxide conversion method according to the present disclosure includes: a step wherein carbon monoxide is formed as carbon dioxide supplied to a reduction electrode is reduced by a voltage applied to a carbon dioxide conversion apparatus; a step wherein hydroxide ion produced by the carbon dioxide reduction reaction is transported to an oxidation electrode; and a step wherein hydrogen supplied to the oxidation electrode is oxidized by reacting with the hydroxide ion, wherein the carbon dioxide conversion apparatus is the carbon dioxide conversion apparatus described above.

In the electrochemical carbon dioxide conversion method according to the present disclosure, the voltage applied to the carbon dioxide conversion apparatus may be 0.5-1.5 V.

In the electrochemical carbon dioxide conversion method according to the present disclosure, the selectivity for carbon monoxide may be 95% or higher.

The carbon dioxide conversion apparatus according to the present disclosure and the carbon dioxide conversion method using the same may significantly save the amount of electrical energy required for electrochemical conversion of carbon dioxide.

In addition, the carbon dioxide conversion apparatus and the electrochemical carbon dioxide conversion method using the same may significantly increase the selectivity for carbon monoxide.

### BRIEF DESCRIPTION OF THE DRAWINGS

FIG. 1 shows a carbon dioxide conversion apparatus according to an exemplary embodiment.

FIG. 2 shows a reduction electrode according to an exemplary embodiment.

FIG. 3 shows a result of analyzing static current during electrochemical conversion of carbon dioxide.

FIG. 4 shows a result of measuring the selectivity for carbon monoxide during electrochemical conversion of carbon dioxide.

FIG. 5 shows a result of measuring current density for carbon monoxide during electrochemical conversion of carbon dioxide.

### DETAILED DESCRIPTION

A carbon dioxide conversion apparatus using hydrogen oxidation reaction and an electrochemical carbon dioxide conversion method using the same are described in detail. The terms used in the present specification are general terms widely used in the art selected while considering the functions in the present disclosure but may vary depending on the intention or precedents in the related art, emergence of new technologies, etc. Unless defined otherwise, the used technical and scientific terms may have meanings commonly understood by those having ordinary knowledge in the technical field to which the present disclosure belongs.

In the present specification and appended claims, the terms such as “include”, “have”, etc. mean the presence of the features or components described in the specification and do not preclude the possibility of addition of one or more other features or components unless specially specified otherwise.

The singular expressions used in the present specification and appended claims include plural expressions unless the context clearly indicates otherwise. In addition, plural expressions include singular expressions unless the context clearly indicates otherwise.

In addition, the numerical ranges used in the present specification include all values within the range between the lower limit and the upper limit, the increments that are logically derived from the range, all the values that are defined doubly and all possible combinations of numerical ranges defined by lower and upper limits. Unless defined otherwise in the specification of the present disclosure, the values outside the above numerical ranges that may occur due to experimental error or rounding of values are also included in the defined numerical ranges.

The terms “about”, etc. used in the present specification and appended claims are used to encompass allowable errors that may exist.

Carbon compounds with high industrial value can be prepared by capturing and electrochemically converting carbon dioxide, which is one of the main causes of global warming. Among the carbon compounds, carbon monoxide is highly useful as a raw material for producing chemicals such as formic acid, acetic acid, phosgene, etc. and the electrochemical carbon dioxide conversion process is being researched actively.

Electrical energy should be applied for electrochemical conversion of thermodynamically stable carbon dioxide. Conventionally, in the electrochemical conversion of carbon dioxide, oxygen evolution reaction (OER) mainly occurs as the opposite reaction of carbon dioxide reduction reaction. When carbon dioxide is reduced using oxygen evolution reaction, the theoretical voltage is high as 1.34 V and overpotential is required additionally to overcome the kinetic barrier. In addition, due to hydrogen evolution reaction (HER) that occurs competitively during the carbon dioxide reduction reaction, selectivity for carbon monoxide is decreased and, thus, the yield of carbon monoxide is decreased.

Therefore, through in-depth researches, the inventors of the present disclosure have developed a carbon dioxide conversion apparatus with high energy efficiency and improved selectivity for carbon monoxide and an electrochemical carbon dioxide conversion method using the same by conducting hydrogen oxidation reaction instead of oxygen evolution reaction as the opposite reaction of carbon dioxide reduction reaction and using a metal nanocluster as a carbon dioxide reduction catalyst.

The carbon dioxide conversion apparatus for preparing carbon monoxide according to the present disclosure includes: an oxidation electrode; a reduction electrode opposing and spaced apart from the oxidation electrode; and an ion-exchange membrane disposed between the oxidation electrode and the reduction electrode, wherein the oxidation electrode includes a hydrogen oxidation reaction (HOR) catalyst and the reduction electrode is a gas diffusion electrode including a metal nanocluster catalyst.

By conducting hydrogen oxidation reaction as the opposite reaction of carbon dioxide reduction reaction, the electrical energy required for the carbon dioxide reduction can be saved significantly. Since the theoretical voltage required for the hydrogen oxidation reaction is about 0.11 V, decreased by about 12 times as compared to the oxygen evolution reaction, carbon dioxide can be converted more effectively.

As a hydrogen oxidation reaction catalyst, any hydrogen oxidation reaction catalyst known in the art may be used. Specifically, a platinum (Pt) catalyst may be used. More specifically, the hydrogen oxidation reaction catalyst may be a platinum (Pt) catalyst supported on a conductive support. The conductive support may be a porous carbon material selected from a group including carbon black, carbon nanotube, graphene, carbon nanofiber and graphitized carbon black or a metal oxide such as tungsten oxide (WO₃), titanium oxide (TiO₂), tin oxide (SnO₂), etc., although the present disclosure is not limited thereto. In a specific exemplary embodiment, the oxidation electrode may be a gas diffusion electrode including a porous carbon material and a platinum (Pt) catalyst supported on the porous carbon material.

In an exemplary embodiment, the reduction electrode may be a gas diffusion electrode including a porous support and a metal nanocluster catalyst fixed in the pores of the porous support.

In the superatomic orbital theory, a nanocluster is regarded as one gigantic atom defined by a specific number of metal atoms and ligands and valence electrons. The nanocluster is more stable than single atoms or nanoparticles and has completely different optical and electrochemical properties from nanoparticles because of stronger molecular properties than metallic properties. In particular, the optical, electrical and catalytic properties of the nanocluster can vary sensitively depending on the number of the metal atoms, the type of the metal atoms and ligands, etc.

In an exemplary embodiment, the metal nanocluster catalyst may have an average particle diameter of 10 nm or smaller or 5 nm or smaller, specifically 2 nm or smaller. Because the average particle diameter of the metal nanocluster catalyst included in the reduction electrode is decreased significantly, the catalytic properties are significantly superior to the nanoparticles having an average particle diameter of tens to hundreds of nanometers. In addition, the selectivity for carbon monoxide can be increased significantly during carbon dioxide conversion because the specific surface area of the catalyst is maximized.

In a specific exemplary embodiment, the metal nanocluster may be represented by Chemical Formula 1:

Mₓ(SR)_{y} [Chemical Formula 1]

wherein M is gold or silver, SR is C₁-C₂₀ alkylthiol, C₃-C₂₀ alkenylthiol, C₃-C₂₀ alkynylthiol, C₆-C₂₀ arylthiol, C₃-C₂₀ cycloalkylthiol, C₅-C₂₀ heteroarylthiol, C₃-C₂₀ heterocycloalkylthiol or C₆-C₂₀ aryl C₁-C₂₀ alkylthiol, x is 14, 25, 38 or 144 and y is 18, 24 or 60.

Because the metal of the metal nanocluster is gold or silver which binds weakly to carbon monoxide, the selectivity for carbon monoxide can be increased significantly, and the ligand (SR) containing an organic thiol-based compound can serve as a protective agent that stabilizes the metal nanocluster.

More specifically, the SR may be C₁-C₁₀ alkylthiol, C₃-C₁₀ alkenylthiol, C₃-C₁₀ alkynylthiol, C₆-C₁₂ arylthiol, C₃-C₁₀ cycloalkylthiol, C₅-C₁₂ heteroarylthiol, C₃-C₁₀ heterocycloalkylthiol or C₆-C₁₀ aryl C₁-C₁₀ alkylthiol. In addition, one or more hydrogen in the SR may be substituted with a substituent. The substituent may be C₁-C₁₀ alkyl, a halogen (—F, —Br, —Cl or —I), nitro, cyano, hydroxy, amino, C₆-C₂₀ aryl, C₂-C₇ alkenyl, C₃-C₂₀ cycloalkyl, C₃-C₂₀ heterocycloalkyl or C₅-C₂₀ heteroaryl, although the present disclosure is not limited thereto.

In another specific exemplary embodiment, the metal nanocluster may be represented by Chemical Formula 2:

AuₓM_{y}(SR)_{z} [Chemical Formula 2]

wherein M is nickel, silver or copper, SR is C₁-C₃₀ alkylthiol, C₆-C₃₀ arylthiol, C₃-C₃₀ cycloalkylthiol, C₅-C₃₀ heteroarylthiol, C₃-C₃₀ heterocycloalkylthiol or C₁-C₃₀ aryl C₁-C₃₀ alkylthiol, x is 2, 4 or 12, y is 2, 3, 4 or 32 and z is 8, 10 or 30.

More specifically, when M is nickel, the metalnanocluster may be Au₂Ni₃(SR)₈, Au₄Ni₂(SR)₈ or Au₂Ni₄(SR)₁₀ and, when M is silver or copper, it may be Au₁₂Ag₃₂(SR)₃₀ or Au₁₂Cu₃₂(SR)₃₀. When the metal of the metal nanocluster catalyst further includes silver, copper and nickel in addition to gold, carbon dioxide can be converted to carbon monoxide more easily at low cost.

One or more hydrogen in the ligand (SR) including the organic thiol-based compound may or may not be substituted with a substituent. The substituent may be C₁-C₁₀ alkyl, a halogen (—F, —Br, —Cl or —I), nitro, cyano, hydroxy, amino, C₆-C₂₀ aryl, C₂-C₇ alkenyl, C₅-C₂₀ cycloalkyl, C₃-C₂₀ heterocycloalkyl or C₄-20 heteroaryl. The number of carbons in the organic thiol-based ligand does not include the number of carbons in the substituent. In addition, in all the functional groups including the alkyl group, the alkyl group may be linear or branched, although the present disclosure is not limited thereto.

The porous support of the oxidation electrode and the reduction electrode may be any porous conductive material having a microporous layer (MPL). Specifically, it may be a carbon material. As described above, the carbon material may be specifically one or more selected from carbon black, carbon nanotube, graphene, carbon nanofiber and graphitized carbon black, more specifically carbon black, although not being limited thereto.

In addition, the porous support may have an average pore size of 10-1000 nm, specifically 10-500 nm, more specifically 10-100 nm. When the pore size is within the above ranges, carbon dioxide may be reduced easily in the pores of the porous support supporting the metal nanocluster, although the present disclosure is not limited thereto.

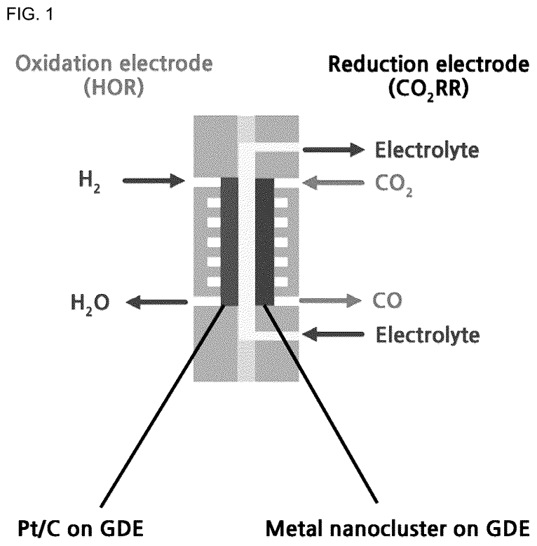

In an exemplary embodiment, as shown in FIG. 1, the reduction electrode may further include a carbon dioxide inlet, a carbon monoxide outlet and a flow path connecting the carbon dioxide inlet and the carbon monoxide outlet on one side, so that carbon dioxide introduced to the reduction electrode is reduced and the produced carbon monoxide can be discharged. The reduction electrode may further include an electrolyte inlet, an electrolyte outlet and an electrolyte flow path connecting the electrolyte inlet and the electrolyte outlet.

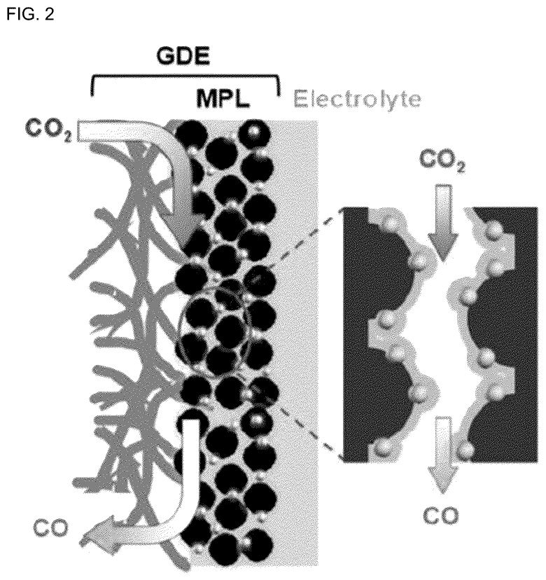

Referring to FIG. 2, the porous support of the reduction electrode may be in contact with the electrolyte. This is advantageous because the transport of carbon dioxide to the catalyst surface in the electrolyte becomes easier and the current density can be improved.

The electrolyte may include a KCl, NaOH or KOH aqueous solution. The electrolyte may specifically have a pH of 7-14, more specifically a pH of 8-14. The concentration of the aqueous solution may be 0.1-10 M, specifically 0.5-5 M, more specifically 0.5-3 M, although not being limited thereto.

In an exemplary embodiment, the oxidation electrode may have a hydrogen inlet, a water outlet and a flow path connecting the hydrogen inlet and the water outlet on one side. Water produced by oxidation of hydrogen introduced to the oxidation electrode may be discharged.

In an exemplary embodiment, the ion-exchange membrane of the carbon dioxide conversion apparatus may be disposed between the oxidation electrode and the reduction electrode opposing and spaced apart from each other, and one side of the ion-exchange membrane may be in contact with one side of the oxidation electrode. Because the oxidation electrode does not include the electrolyte and the spacing between the oxidation electrode and the ion-exchange membrane is minimized, the solution ionic resistance resulting from the presence of the electrolyte between the oxidation electrode and the ion-exchange membrane can be reduced and the overpotential of the carbon dioxide reduction reaction can be decreased.

In an exemplary embodiment, the ion-exchange membrane may be an anion-exchange membrane (AEM). The ion-exchange membrane selectively transports anions only, so that the anion that has passed through the ion-exchange membrane can react with and oxidize hydrogen at the oxidation electrode.

Specifically, the ion-exchange membrane must be durable under a strong base environment, have low gas permeability and have high ionic conductivity. The ion-exchange membrane may be prepared from an ion-exchange resin, ionomer or film known in the art or may be purchased. For example, Nafion™ membrane, which is a perfluorinated sulfonate-based polymer membrane available from DuPont (USA), and similar commercial membranes such as Solvey's Aquivion PFSA membrane, Fumatek's Fumasep anion-exchange membrane, Dioxide Materials' anion-exchange membrane, Orion Polymer's anion-exchange membrane, Asahi Chemicals' Aciplex-S membrane, Dow Chemicals' Dow membrane, Asahi Glass's Flemion membrane, Gore & Associates' GoreSelcet membrane, etc. may be used, although not being limited thereto.

The present disclosure also provides a carbon dioxide conversion method using the carbon dioxide conversion apparatus described above.

The carbon dioxide conversion method according to the present disclosure includes: a step wherein carbon monoxide is formed as carbon dioxide supplied to a reduction electrode is reduced by a voltage applied to a carbon dioxide conversion apparatus; a step wherein hydroxide ion produced by the carbon dioxide reduction reaction is transported to an oxidation electrode; and a step wherein hydrogen supplied to the oxidation electrode is oxidized by reacting with the hydroxide ion.

By applying electrical energy to the carbon dioxide conversion apparatus, carbon dioxide may be converted electrochemically as electrons are transported due to the potential difference between the oxidation electrode and the reduction electrode. Carbon dioxide gas is introduced into the carbon dioxide inlet and is reduced to carbon monoxide as the carbon dioxide passes through the porous support of the reduction electrode which is in contact with the electrolyte. As described above, the selectivity for carbon dioxide reduction reaction, which competes with hydrogen evolution reaction, can be improved significantly by the metal nanocluster catalyst dispersed uniformly and fixed on the surface of the pores of the porous support. In a specific exemplary embodiment, the selectivity for carbon monoxide may be 95% or higher or 96% or higher, specifically 98% or higher.

In an exemplary embodiment, carbon monoxide and hydroxide ion can be produced by the carbon dioxide reduction reaction. The carbon monoxide may be obtained through the carbon monoxide outlet and the hydroxide ion (OH) may be transported to the oxidation electrode through the ion-exchange membrane.

The hydroxide ion that has been transported to the oxidation electrode may react with hydrogen introduced to the hydrogen inlet to produce water. By adopting hydrogen oxidation reaction as the opposite reaction of the carbon dioxide reduction reaction, the electrical energy required for the carbon dioxide conversion can be reduced. Specifically, the voltage applied to the carbon dioxide reduction apparatus may be 0.5-1.5 V or 0.6-1.4 V, specifically 0.8-1.3 V. Since the theoretical voltage and overpotential can be reduced significantly through the hydrogen oxidation reaction as compared to the oxygen evolution reaction, which is the conventional opposite reaction of the carbon dioxide reduction reaction, a carbon dioxide conversion process with superior energy efficiency can be implemented.

Hereinafter, the present disclosure is described in detail through examples.

### Example 1

After dissolving 0.5 mmol of HAuCl₄·3H₂O and 0.58 mmol of tetraoctylammonium bromide in 15 mL of tetrahydrofuran, 2.5 mmol of n-hexanethiol (C₆H₁₃SH) was added dropwise. After stirring for 60 minutes, 5 mmol of NaBH₄ (in 5 mL of H₂O) was added. Then, Au₂₅(SC₆H₁₃)₁₈ was synthesized by stirring for 5 hours. After the reaction was completed, impurities were removed by washing 5 times with water and methanol. After washing additionally with ethanol and extracting with a mixed solvent of acetonitrile and acetone (volume ratio=1:1), high-purity Au₂₅(SC₆H₁₃)₁₈ was obtained by drying the same.

After mixing a solution obtained by dissolving 30 μg of the metal nanocluster in 160 μL of dichloromethane with 160 μL of acetone, a nanocluster dispersion was prepared by sonicating for about 1 minute. Then, a reduction electrode was prepared by solution-coating the prepared nanocluster dispersion on a gas diffusion-type microporous carbon electrode (GDE (W1S1011, Ce-Tech)) with an area of 2.5×2.5 cm². The average loading amount of the nanocluster was 0.63 nmol/cm².

An oxidation electrode was prepared by coating a solution obtained by dispersing 3.125 mg of a platinum (Pt)-supported carbon catalyst (Pt/C, Premetek) and 31.25 μL of an ionomer (Nafion, DuPont) in 125 μL of an isopropyl alcohol solvent on a gas diffusion-type microporous carbon electrode (GDE (Sigracet 39BB, SGL Carbon)) with an area of 2.5×2.5 cm².

A carbon dioxide reduction apparatus was fabricated by deposing a cation-exchange membrane (Nafion 212, DuPont) between the reduction electrode and the oxidation electrode so that it was in contact with one side of the oxidation electrode and sealing the same.

### Example 2

A carbon dioxide reduction apparatus was fabricated in the same manner as in Example 1 except that a cation-exchange membrane was not used.

### Example 3

After dissolving 40.0 mg of AgNO₃ in 2 mL of methanol, 15 mL of tetrahydrofuran was added. After stirring and adding 0.090 mL of 2,4-dimethylbenzenethiol, the reaction mixture was stirred in an ice bath for 20 minutes. After adding 6 mg of tetraphosphonium bromide dissolved in 1 mL of methanol and then adding 15 mg of NaBH₄ (0.4 mmol) dissolved in 0.5 mL of ice-cold water, the reaction mixture was stirred for 3 hours. After aging for 12 hours, the precipitate obtained through centrifugation was washed with methylene chloride and methanol to remove impurities. After dissolving 3 mg of the product in 0.5 mL of methylene chloride, Ag₂₅(SPhMe₂)₁₈ was obtained by conducting recrystallization by adding 5 mL of n-hexane (Ph=phenyl, Me=methyl).

### Example 4

After adding 0.097 g of AgBF₄ (0.5 mmol), 0.061 mL of t-butylacetylene (0.5 mmol), 0.070 mL of triethyl amine (0.5 mmol) and 0.011 g of tetrabutylammonium chloride (0.04 mmol) to a flask, 1 mL of tetrahydrofuran was added and the mixture was stirred for 4 hours. After removing the solvent through distillation under reduced pressure, a [Ag₁₄(C≡CtBu)₁₂Cl]⁺ nanocluster was obtained by removing impurities by washing with pure water and n-pentane (tBu=t-butyl).

### Comparative Example 1

A carbon dioxide reduction apparatus was fabricated in the same manner as in Example 1 except that Ni foam (NIF, 29-04275-01, Invisible Inc.) with an area of 3×3 cm² was used as the oxidation electrode and a cation-exchange membrane was used as the ion-exchange membrane.

### Comparative Example 2

A carbon dioxide reduction apparatus was fabricated in the same manner as in Example 1 except that Ag nanoparticles (Ag NPs, Dioxide Materials) with an area of 2.5×2.5 cm² were used as the reduction electrode.

### Comparative Example 3

A carbon dioxide reduction apparatus was fabricated in the same manner as in Example 1 except that the oxidation electrode was prepared by coating a solution obtained by dispersing 30 mg of Au/C (Premetek) and 90 μL of an ionomer (Nafion, DuPont) in 1.2 mL of an isopropyl alcohol solvent on a gas diffusion-type microporous carbon electrode (GDE (W1S1011, Ce-Tech) with an area of 2.5×2.5 cm².

### Test Examples and Comparative Test Examples

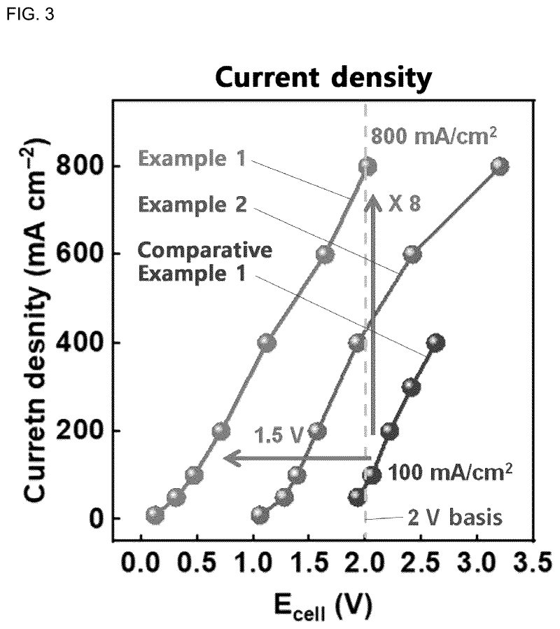

FIG. 3 shows a result of analyzing static current during electrochemical conversion of carbon dioxide using the carbon dioxide reduction apparatuses fabricated in Examples 1 and 2 and Comparative Example 1. During the carbon dioxide reduction, the voltage was decreased by about 0.8 V and 1.5 V, respectively, for Examples 1 and 2 wherein hydrogen oxidation reaction occurs at the oxidation electrode as compared to Comparative Example 1 wherein oxygen evolution reaction occurs at the oxidation electrode whereby water molecule is oxidized and oxygen gas is produced.

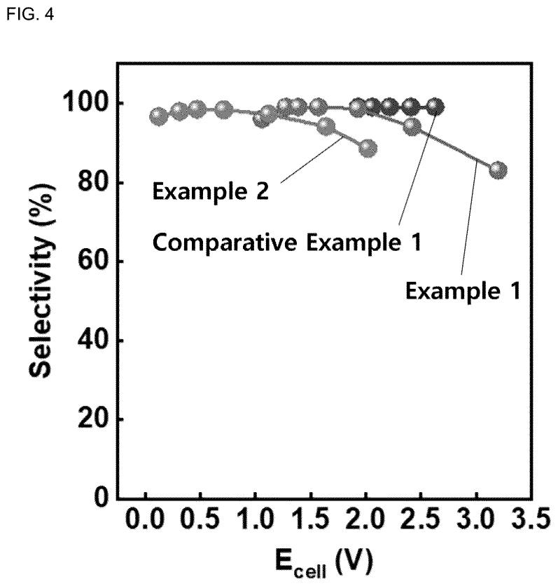

FIG. 4 shows a result of measuring the selectivity for carbon monoxide during electrochemical conversion of carbon dioxide using the carbon dioxide reduction apparatus fabricated in Example 1. As seen from FIG. 4, the carbon monoxide selectivity was 95% not only at the low current density but also at the high current density of 600 mA·cm⁻², confirming that the selectivity of the carbon dioxide reduction reaction was significantly higher than the competitive hydrogen evolution reaction.

As can be seen from FIG. 3 and FIG. 4, the theoretical voltage can be decreased through the hydrogen oxidation reaction and the overpotential occurring during the electrochemical reaction can be reduced. By using the metal nanocluster catalyst as the catalyst of the reduction electrode, the carbon monoxide selectivity and the current density for the catalytic reaction can be improved greatly and carbon dioxide can be converted to carbon monoxide with high efficiency.

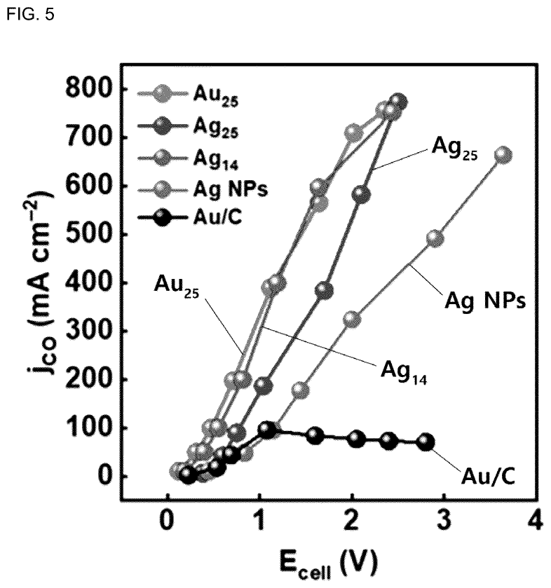

FIG. 5 shows a result of measuring current density for carbon monoxide during electrochemical conversion of carbon dioxide using the carbon dioxide reduction apparatuses fabricated in Examples 1, 3 and 4. When the metal nanocluster catalysts prepared in the examples were used, fast onset voltage (0.1 V) and high current density for carbon monoxide production (750 mA/cm² at 2.4 V) were identified as compared to Comparative Examples 2 and 3.

Although not shown in the figures, the compounds prepared in the examples showed superior effect in terms of fast onset voltage (0.1 V) and high current density for carbon monoxide production as compared to Comparative Examples 1-3.

Although specific exemplary embodiments of the present disclosure were described above through specific examples and drawings, they are provided only to help the overall understanding of the present disclosure. The present disclosure is not limited by the specific examples and those having ordinary knowledge in the art to which the present disclosure belongs can make various modifications and changes based thereon.

Accordingly, the scope of the present disclosure is not limited to the described specific examples but include the equivalents and modifications of the appended claims.

What is claimed is:

1. A carbon dioxide conversion apparatus for preparing carbon monoxide, comprising:
an oxidation electrode; and
a reduction electrode opposing and spaced apart from the oxidation electrode,
wherein
the oxidation electrode comprises a hydrogen oxidation reaction (HOR) catalyst, and
the reduction electrode is a gas diffusion electrode comprising a metal nanocluster catalyst.

2. The carbon dioxide conversion apparatus according to claim 1, wherein the hydrogen oxidation reaction catalyst comprises platinum.

3. The carbon dioxide conversion apparatus according to claim 1, wherein the gas diffusion electrode comprises a porous support and a metal nanocluster catalyst fixed in the pores of the porous support.

4. The carbon dioxide conversion apparatus according to claim 3, wherein the metal nanocluster catalyst has an average particle diameter of 10 nm or smaller.

5. The carbon dioxide conversion apparatus according to claim 4, wherein the metal nanocluster catalyst is represented by Chemical Formula 1:
Mₓ(SR)_{y} [Chemical Formula 1]
wherein M is gold or silver, SR is C₁-C₂₀ alkylthiol, C₃-C₂₀ alkenylthiol, C₃-C₂₀ alkynylthiol, C₆-C₂₀ arylthiol, C₃-C₂₀ cycloalkylthiol, C₅-C₂₀ heteroarylthiol, C₃-C₂₀ heterocycloalkylthiol or C₆-C₂₀ aryl C₁-C₂₀ alkylthiol, x is 14, 25, 38 or 144 and y is 18, 24 or 60.

6. The carbon dioxide conversion apparatus according to claim 4, wherein the metal nanocluster catalyst is represented by Chemical Formula 2:
AuₓM_{y}(SR)_{z} [Chemical Formula 2]
wherein M is nickel, silver or copper, SR is C₁-C₃₀ alkylthiol, C₆-C₃₀ arylthiol, C₃-C₃₀ cycloalkylthiol, C₅-C₃₀ heteroarylthiol, C₃-C₃₀ heterocycloalkylthiol or C₁-C₃₀ aryl C₁-C₃₀ alkylthiol, x is 2, 4 or 12, y is 2, 3, 4 or 32 and z is 8, 10 or 30.

7. The carbon dioxide conversion apparatus according to claim 1,
wherein
the reduction electrode further comprises a carbon dioxide inlet and a carbon monoxide outlet on one side, and
the oxidation electrode further comprises a hydrogen inlet and a water outlet on one side.

8. The carbon dioxide conversion apparatus according to claim 7, wherein each of the oxidation electrode and the reduction electrode further comprises a flow path connecting the inlet and the outlet.

9. The carbon dioxide conversion apparatus according to claim 1,
wherein
the carbon dioxide conversion apparatus for preparing carbon monoxide further comprises an ion-exchange membrane disposed between the oxidation electrode and the reduction electrode, and
the oxidation electrode contacts with one side of the ion-exchange membrane.

10. The carbon dioxide conversion apparatus according to claim 9, wherein the ion-exchange membrane is an anion- or cation-exchange membrane.

11. An electrochemical carbon dioxide conversion method comprising:
a step wherein carbon monoxide is formed as carbon dioxide supplied to a reduction electrode is reduced by a voltage applied to a carbon dioxide conversion apparatus;
a step wherein hydroxide ion produced by the carbon dioxide reduction reaction is transported to an oxidation electrode; and
a step wherein hydrogen supplied to the oxidation electrode is oxidized by reacting with the hydroxide ion,
wherein the carbon dioxide conversion apparatus is the carbon dioxide conversion apparatus according to claim 1.

12. The electrochemical carbon dioxide conversion method according to claim 11, wherein the voltage applied to the carbon dioxide conversion apparatus is 0-3.0 V.

13. The electrochemical carbon dioxide conversion method according to claim 11, wherein the selectivity for carbon monoxide is 95% or higher.
